(19) United States
(12) Patent Application Publication
(10) Pub. No.: US 2026/0121897 A1
(43) Pub. Date: Apr. 30, 2026

(54) METHOD AND DEVICE FOR PERFORMING WIRELESS COMMUNICATION USING RELAYS

(71) Applicant: KT CORPORATION, Gyeonggi-do (KR)

(72) Inventors: Sung Hyun KIM, Gyeonggi-do (KR); Kyu Jin PARK, Gyeonggi-do (KR); Sung Kwan KIM, Gyeonggi-do (KR)

(73) Assignee: KT CORPORATION, Gyeonggi-do (KR)

(21) Appl. No.: 19/116,953

(22) PCT Filed: Oct. 4, 2023
(86) PCT No.: PCT/KR2023/015232

§ 371 Date: Mar. 28, 2025

(30) Foreign Application Priority Data
Sep. 28, 2022 (KR) 10-2022-0123458
Sep. 27, 2023 (KR) 10-2023-0131073

(51) Int. Cl. H04L 27/26; H04W 4/02

(52) U.S. Cl. CPC H04L 27/261; H04W 4/025

(57) ABSTRACT

Provided are a method and device for performing wireless communication using relays. The method may include: receiving configuration information for sounding reference signals (SRSs) from a base station; transmitting each of the SRSs to the base station in successive time periods according to the ON/OFF states of the relays; and performing wireless communication with the base station via a relay determined, on the basis of the transmitted SRSs, to have a UE located within the coverage thereof.

### TECHNICAL FIELD

The disclosure relates to a method and device for performing wireless communication using a repeater in a next-generation radio access network (hereinafter, “new radio (NR)”).

### BACKGROUND ART

Recently, the 3rd generation partnership project (3GPP) has approved the “Study on New Radio Access Technology”, which is a study item for research on next-generation/5G radio access technology (hereinafter, referred to as “new radio” or “NR”). On the basis of the Study on New Radio Access Technology, Radio Access Network Working Group 1 (RAN WG1) has been discussing frame structures, channel coding and modulation, waveforms, multiple access methods, and the like for the new radio (NR). It is required to design the NR not only to provide an improved data transmission rate as compared with the long term evolution (LTE)/LTE-Advanced, but also to meet various requirements in detailed and specific usage scenarios.

An enhanced mobile broadband (eMBB), massive machine-type communication (mMTC), and ultra reliable and low latency communication (URLLC) are proposed as representative usage scenarios of the NR. In order to meet the requirements of the individual scenarios, it is required to design the NR to have flexible frame structures, compared with the LTE/LTE-Advanced.

Because the requirements for data rates, latency, reliability, coverage, etc. are different from each other, there is a need for a method for efficiently multiplexing a radio resource unit based on different numerologies from other (e.g., subcarrier spacing, subframe, Transmission Time Interval (TTI), etc.) as a method for efficiently satisfying each usage scenario requirement through a frequency band constituting any NR system.

As part of this aspect, when applying repeaters to expand wireless coverage in wireless networks, a specific design is required to minimize energy consumption more efficiently.

### DETAILED DESCRIPTION OF THE INVENTION

### Technical Problem

The disclosure may provide a method and device for performing wireless communication using a repeater in a wireless network in NR.

### Technical Solution

In an aspect, the disclosure may provide a method for a user equipment (UE) to perform wireless communication using a repeater. The method may include receiving configuration information about a sounding reference signal (SRS) from a base station, transmitting the SRS to the base station in each of sequential time durations according to an on/off state of repeaters based on the configuration information about the SRS, and performing wireless communication with the base station through a repeater determined to have the UE located in coverage based on the transmitted SRS.

In another aspect, the disclosure may provide a method for a base station to perform wireless communication using a repeater. The method may include transmitting configuration information about a sounding reference signal (SRS) to a UE, receiving the SRS from the UE in each of sequential time durations according to an on/off state of repeaters based on the configuration information about the SRS, determining a repeater having the UE located in coverage among the repeaters based on the received SRS, and performing wireless communication with the UE through the determined repeater.

In another aspect, the disclosure may provide a user equipment (UE) performing wireless communication using a repeater. The UE may include a transmitter, a receiver, and a controller configured to control an operation of the transmitter and the receiver, wherein the controller receives configuration information about a sounding reference signal (SRS) from a base station, transmits the SRS to the base station in each of sequential time durations according to an on/off state of repeaters based on the configuration information about the SRS, and performs wireless communication with the base station through a repeater determined to have the UE located in coverage based on the transmitted SRS.

In an aspect, the disclosure may provide a base station performing wireless communication using a repeater. The base station may include a transmitter, a receiver, and a controller controlling an operation of the transmitter and the receiver, wherein the controller transmits configuration information about a sounding reference signal (SRS) to a UE, receives the SRS from the UE in each of sequential time durations according to an on/off state of repeaters based on the configuration information about the SRS, determines a repeater having the UE located in coverage among the repeaters based on the received SRS, and performs wireless communication with the UE through the determined repeater.

### Advantageous Effects

According to embodiments of the disclosure, wireless communication may performed using a repeater in a wireless network in NR.

Further, according to the present embodiments, power consumption of repeaters may be reduced and interference of wireless signals may be minimized by controlling only necessary repeaters to operate and disabling the operations of unnecessary repeaters.

### BRIEF DESCRIPTION OF DRAWINGS

FIG. 1 is a view schematically illustrating an NR wireless communication system in accordance with embodiments of the present disclosure.

FIG. 2 is a view schematically illustrating a frame structure in an NR system in accordance with embodiments of the present disclosure.

FIG. 3 is a view for explaining resource grids supported by a radio access technology in accordance with embodiments of the present disclosure.

FIG. 4 is a view for explaining bandwidth parts supported by a radio access technology in accordance with embodiments of the present disclosure.

FIG. 5 is a view illustrating an example of a synchronization signal block in a radio access technology in accordance with embodiments of the present disclosure.

FIG. 6 is a signal diagram for explaining a random access procedure in a radio access technology in accordance with embodiments of the present disclosure.

FIG. 7 is a view for explaining CORESET.

FIG. 8 is a view illustrating controlling a relaying of a wireless signal performed by a repeater between a button structure and a UE according to the present embodiments.

FIG. 9 is a view illustrating a procedure of performing wireless communication using a repeater by a UE according to an embodiment.

FIGS. 10 to 12 are views illustrating determining a repeater located in coverage by a UE according to the present embodiments.

FIG. 13 is a view illustrating a procedure of performing wireless communication using a repeater by a base station according to an embodiment.

FIG. 14 is a view illustrating a configuration of a UE according to another embodiment.

FIG. 15 is a view illustrating a configuration of a base station according to another embodiment.

### MODE FOR CARRYING OUT THE INVENTION

Hereinafter, some embodiments of the present disclosure will be described in detail with reference to the accompanying illustrative drawings. In the drawings, like reference numerals are used to denote like elements throughout the drawings, even if they are shown on different drawings. Further, in the following description of the present disclosure, a detailed description of known functions and configurations incorporated herein will be omitted when it may make the subject matter of the present disclosure rather unclear. When the expression “include”, “have”, “comprise”, or the like as mentioned herein is used, any other part may be added unless the expression “only” is used. When an element is expressed in the singular, the element may cover the plural form unless a special mention is explicitly made of the element.

In addition, terms, such as first, second, A, B, (A), (B) or the like may be used herein when describing components of the present disclosure. Each of these terminologies is not used to define an essence, order or sequence of a corresponding component but used merely to distinguish the corresponding component from other component(s).

In describing the positional relationship between components, if two or more components are described as being “connected”, “combined”, or “coupled” to each other, it should be understood that two or more components may be directly “connected”, “combined”, or “coupled” to each other, and that two or more components may be “connected”, “combined”, or “coupled” to each other with another component “interposed” therebetween. In this case, another component may be included in at least one of the two or more components that are “connected”, “combined”, or “coupled” to each other.

In the description of a sequence of operating methods or manufacturing methods, for example, the expressions using “after”, “subsequent to”, “next”, “before”, and the like may also encompass the case in which operations or processes are performed discontinuously unless “immediately” or “directly” is used in the expression.

Numerical values for components or information corresponding thereto (e.g., levels or the like), which are mentioned herein, may be interpreted as including an error range caused by various factors (e.g., process factors, internal or external impacts, noise, etc.) even if an explicit description thereof is not provided.

The wireless communication system in the present specification refers to a system for providing various communication services, such as a voice service and a data service, using radio resources. The wireless communication system may include a user equipment (UE), a base station, a core network, and the like.

Embodiments disclosed below may be applied to a wireless communication system using various radio access technologies. For example, the embodiments may be applied to various radio access technologies such as code division multiple access (CDMA), frequency division multiple access (FDMA), time division multiple access (TDMA), orthogonal frequency division multiple access (OFDMA), single-carrier frequency division multiple access (SC-FDMA), non-orthogonal multiple access (NOMA), or the like. In addition, the radio access technology may refer to respective generation communication technologies established by various communication organizations, such as 3GPP, 3GPP2, Wi-Fi, Bluetooth, IEEE, ITU, or the like, as well as a specific access technology. For example, CDMA may be implemented as a wireless technology such as universal terrestrial radio access (UTRA) or CDMA2000. TDMA may be implemented as a wireless technology such as global system for mobile communications (GSM)/general packet radio service (GPRS)/enhanced data rates for GSM evolution (EDGE). OFDMA may be implemented as a wireless technology such as IEEE (Institute of Electrical and Electronics Engineers) 802.11 (Wi-Fi), IEEE 802.16 (WiMAX), IEEE 802-20, evolved UTRA (E-UTRA), and the like. IEEE 802.16m is evolution of IEEE 802.16e, which provides backward compatibility with systems based on IEEE 802.16e. UTRA is a part of a universal mobile telecommunications system (UMTS). 3GPP (3rd-generation partnership project) LTE (long-term evolution) is a part of E-UMTS (evolved UMTS) using evolved-UMTS terrestrial radio access (E-UTRA), which adopts OFDMA in a downlink and SC-FDMA in an uplink. As described above, the embodiments may be applied to radio access technologies that have been launched or commercialized, and may be applied to radio access technologies that are being developed or will be developed in the future.

The UE used in the specification must be interpreted as a broad meaning that indicates a device including a wireless communication module that communicates with a base station in a wireless communication system. For example, the UE includes user equipment (UE) in WCDMA, LTE, NR, HSPA, IMT-2020 (5G or New Radio), and the like, a mobile station in GSM, a user terminal (UT), a subscriber station (SS), a wireless device, and the like. In addition, the UE may be a portable user device, such as a smart phone, or may be a vehicle, a device including a wireless communication module in the vehicle, and the like in a V2X communication system according to the usage type thereof. In the case of a machine-type communication (MTC) system, the UE may refer to an MTC terminal, an M2M terminal, or a URLLC terminal, which employs a communication module capable of performing machine-type communication.

A base station or a cell in the present specification refers to an end that communicates with a UE through a network and encompasses various coverage regions such as a Node-B, an evolved Node-B (eNB), a gNode-B, a low-power node (LPN), a sector, a site, various types of antennas, a base transceiver system (BTS), an access point, a point (e.g., a transmission point, a reception point, or a transmission/reception point), a relay node, a megacell, a macrocell, a microcell, a picocell, a femtocell, a remote radio head (RRH), a radio unit (RU), a small cell, and the like. In addition, the cell may be used as a meaning including a bandwidth part (BWP) in the frequency domain. For example, the serving cell may refer to an active BWP of a UE.

The various cells listed above are provided with a base station controlling one or more cells, and the base station may be interpreted as two meanings. The base station may be 1) a device for providing a megacell, a macrocell, a microcell, a picocell, a femtocell, or a small cell in connection with a wireless region, or the base station may be 2) a wireless region itself. In the above description 1), the base station may be the devices controlled by the same entity and providing predetermined wireless regions or all devices interacting with each other and cooperatively configuring a wireless region. For example, the base station may be a point, a transmission/reception point, a transmission point, a reception point, and the like according to the configuration method of the wireless region. In the above description 2), the base station may be the wireless region in which a user equipment (UE) may be enabled to transmit data to and receive data from the other UE or a neighboring base station.

In this specification, the cell may refer to coverage of a signal transmitted from a transmission/reception point, a component carrier having coverage of a signal transmitted from a transmission/reception point (or a transmission point), or a transmission/reception point itself.

An uplink (UL) refers to a scheme of transmitting data from a UE to a base station, and a downlink (DL) refers to a scheme of transmitting data from a base station to a UE. The downlink may mean communication or communication paths from multiple transmission/reception points to a UE, and the uplink may mean communication or communication paths from a UE to multiple transmission/reception points. In the downlink, a transmitter may be a part of the multiple transmission/reception points, and a receiver may be a part of the UE. In addition, in the uplink, the transmitter may be a part of the UE, and the receiver may be a part of the multiple transmission/reception points.

The uplink and downlink transmit and receive control information over a control channel, such as a physical downlink control channel (PDCCH) and a physical uplink control channel (PUCCH). The uplink and downlink transmit and receive data over a data channel such as a physical downlink shared channel (PDSCH) and a physical uplink shared channel (PUSCH). Hereinafter, the transmission and reception of a signal over a channel, such as PUCCH, PUSCH, PDCCH, PDSCH, or the like, may be expressed as “PUCCH, PUSCH, PDCCH, PDSCH, or the like is transmitted and received”.

For the sake of clarity, the following description will focus on 3GPP LTE/LTE-A/NR (New Radio) communication systems, but technical features of the disclosure are not limited to the corresponding communication systems.

The 3GPP has been developing a 5G (5th-Generation) communication technology in order to meet the requirements of a next-generation radio access technology of ITU-R after studying 4G (4th-generation) communication technology. Specifically, 3GPP is developing, as a 5G communication technology, LTE-A pro by improving the LTE-Advanced technology so as to conform to the requirements of ITU-R and a new NR communication technology that is totally different from 4G communication technology. LTE-A pro and NR all refer to the 5G communication technology. Hereinafter, the 5G communication technology will be described on the basis of NR unless a specific communication technology is specified.

Various operating scenarios have been defined in NR in consideration of satellites, automobiles, new verticals, and the like in the typical 4G LTE scenarios so as to support an enhanced mobile broadband (eMBB) scenario in terms of services, a massive machine-type communication (mMTC) scenario in which UEs spread over a broad region at a high UE density, thereby requiring low data rates and asynchronous connections, and an ultra-reliability and low-latency (URLLC) scenario that requires high responsiveness and reliability and supports high-speed mobility.

In order to satisfy such scenarios, NR introduces a wireless communication system employing a new waveform and frame structure technology, a low-latency technology, a super-high frequency band (mmWave) support technology, and a forward compatible provision technology. In particular, the NR system has various technological changes in terms of flexibility in order to provide forward compatibility. The primary technical features of NR will be described below with reference to the drawings.

### <Overview of NR System>

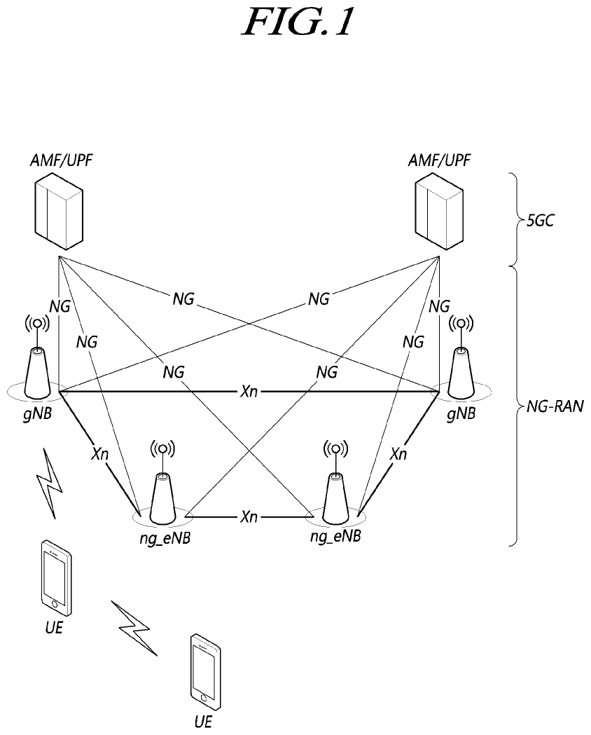

FIG. 1 is a view schematically illustrating an NR system

Referring to FIG. 1, the NR system is divided into a 5G core network (5GC) and an NG-RAN part. The NG-RAN includes gNBs and ng-eNBs providing user plane (SDAP/PDCP/RLC/MAC/PHY) and user equipment (UE) control plane (RRC) protocol ends. The gNBs or the gNB and the ng-eNB are connected to each other through Xn interfaces. The gNB and the ng-eNB are connected to the 5GC through NG interfaces, respectively. The 5GC may be configured to include an access and mobility management function (AMF) for managing a control plane, such as a UE connection and mobility control function, and a user plane function (UPF) controlling user data. NR supports both frequency bands below 6 GHZ (frequency range 1 FR1 FR1) and frequency bands equal to or greater than 6 GHz (frequency range 2 FR2 FR2).

The gNB denotes a base station that provides a UE with an NR user plane and control plane protocol end. The ng-eNB denotes a base station that provides a UE with an E-UTRA user plane and control plane protocol end. The base station described in the present specification should be understood as encompassing the gNB and the ng-eNB. However, the base station may be also used to refer to the gNB or the ng-eNB separately from each other, as necessary.

### <NR Waveform, Numerology, and Frame Structure>

NR uses a CP-OFDM waveform using a cyclic prefix for downlink transmission and uses CP-OFDM or DFT-s-OFDM for uplink transmission. OFDM technology is easy to combine with a multiple-input multiple-output (MIMO) scheme and allows a low-complexity receiver to be used with high frequency efficiency.

Since the three scenarios described above have different requirements for data rates, delay rates, coverage, and the like from each other in NR, it is necessary to efficiently satisfy the requirements for each scenario over frequency bands constituting the NR system. To this end, a technique for efficiently multiplexing radio resources based on a plurality of different numerologies has been proposed.

Specifically, the NR transmission numerology is determined on the basis of subcarrier spacing and a cyclic prefix (CP). As shown in Table 1 below, “u” is used as an exponential value of 2 so as to be changed exponentially on the basis of 15 kHz.

TABLE 1

| | Subcarrier | | Supported for | Supported for |
|---|---|---|---|---|
| μ | spacing | Cyclic prefix | data | synch |
| 0 | 15 | normal | Yes | Yes |
| 1 | 30 | normal | Yes | Yes |
| 2 | 60 | Normal, | Yes | No |
| | | Extended | | |
| 3 | 120 | normal | Yes | Yes |
| 4 | 240 | normal | No | Yes |

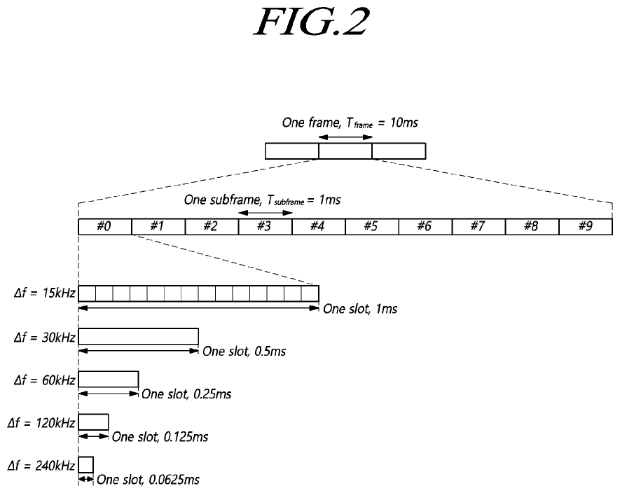

As shown in Table 1 above, NR may have five types of numerologies according to subcarrier spacing. This is different from LTE, which is one of the 4G-communication technologies, in which the subcarrier spacing is fixed to 15 kHz. Specifically, in NR, subcarrier spacing used for data transmission is 15, 30, 60, or 120 kHz, and subcarrier spacing used for synchronization signal transmission is 15, 30, 120, or 240 KHz. In addition, an extended CP is applied only to the subcarrier spacing of 60 KHz. A frame that includes 10 subframes each having the same length of 1 ms and has a length of 10 ms is defined in the frame structure in NR. One frame may be divided into half frames of 5 ms, and each half frame includes 5 subframes. In the case of a subcarrier spacing of 15 kHz, one subframe includes one slot, and each slot includes 14 OFDM symbols. FIG. 2 is a view for explaining a frame structure in an NR system to which the present embodiment may be applied. Referring to FIG. 2, a slot includes 14 OFDM symbols, which are fixed, in the case of a normal CP, but the length of the slot in the time domain may be varied depending on subcarrier spacing. For example, in the case of a numerology having a subcarrier spacing of 15 kHz, the slot is configured to have the same length of 1 ms as that of the subframe. On the other hand, in the case of a numerology having a subcarrier spacing of 30 kHz, the slot includes 14 OFDM symbols, but one subframe may include two slots each having a length of 0.5 ms. That is, the subframe and the frame may be defined using a fixed time length, and the slot may be defined as the number of symbols such that the time length thereof is varied depending on the subcarrier spacing.

NR defines a basic unit of scheduling as a slot and also introduces a minislot (or a subslot or a non-slot-based schedule) in order to reduce a transmission delay of a radio section. If wide subcarrier spacing is used, the length of one slot is shortened in inverse proportion thereto, thereby reducing a transmission delay in the radio section. A minislot (or subslot) is intended to efficiently support URLLC scenarios, and the minislot may be scheduled in 2, 4, or 7 symbol units.

In addition, unlike LTE, NR defines uplink and downlink resource allocation as a symbol level in one slot. In order to reduce a HARQ delay, the slot structure capable of directly transmitting HARQ ACK/NACK in a transmission slot has been defined. Such a slot structure is referred to as a “self-contained structure”, which will be described.

NR was designed to support a total of 256 slot formats, and 62 slot formats thereof are used in 3GPP Rel-15. In addition, NR supports a common frame structure constituting an FDD or TDD frame through combinations of various slots. For example, NR supports i) a slot structure in which all symbols of a slot are configured for a downlink, ii) a slot structure in which all symbols are configured for an uplink, and iii) a slot structure in which downlink symbols and uplink symbols are mixed. In addition, NR supports data transmission that is scheduled to be distributed to one or more slots. Accordingly, the base station may inform the UE of whether the slot is a downlink slot, an uplink slot, or a flexible slot using a slot format indicator (SFI). The base station may inform a slot format by instructing, using the SFI, the index of a table configured through UE-specific RRC signaling. Further, the base station may dynamically instruct the slot format through downlink control information (DCI) or may statically or quasi-statically instruct the same through RRC signaling.

### <Physical Resources of NR>

With regard to physical resources in NR, antenna ports, resource grids, resource elements, resource blocks, bandwidth parts, and the like are taken into consideration.

The antenna port is defined to infer a channel carrying a symbol on an antenna port from the other channel carrying another symbol on the same antenna port. If large-scale properties of a channel carrying a symbol on an antenna port can be inferred from the other channel carrying a symbol on another antenna port, the two antenna ports may have a quasi-co-located or quasi-co-location (QC/QCL) relationship. The large-scale properties include at least one of delay spread, Doppler spread, a frequency shift, an average received power, and a received timing.

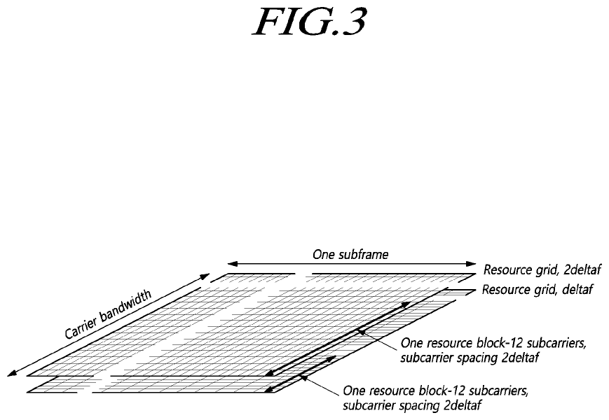

FIG. 3 illustrates resource grids supported by a radio access technology in accordance with embodiments of the present disclosure.

Referring to FIG. 3, resource grids may exist according to respective numerologies because NR supports a plurality of numerologies in the same carrier. In addition, the resource grids may exist depending on antenna ports, subcarrier spacing, and transmission directions.

A resource block includes 12 subcarriers and is defined only in the frequency domain. In addition, a resource element includes one OFDM symbol and one subcarrier. Therefore, as shown in FIG. 3, the size of one resource block may be varied according to the subcarrier spacing. Further, “Point A” that acts as a common reference point for the resource block grids, a common resource block, and a virtual resource block are defined in NR.

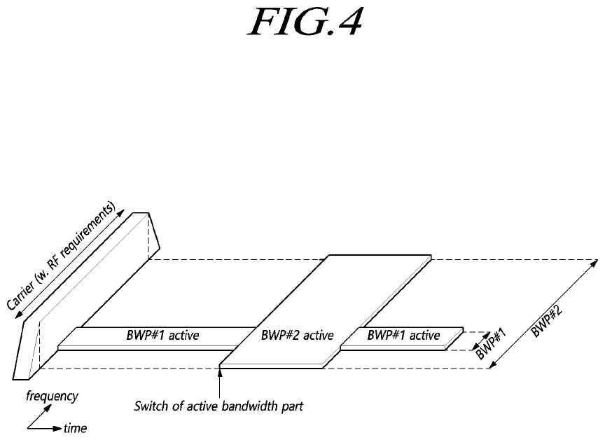

FIG. 4 illustrates bandwidth parts supported by a radio access technology in accordance with embodiments of the present disclosure.

Unlike LTE in which the carrier bandwidth is fixed to 20 MHz, the maximum carrier bandwidth is configured as 50 MHz to 400 MHz depending on the subcarrier spacing in NR. Therefore, it is not assumed that all UEs use the entire carrier bandwidth. Accordingly, as shown in FIG. 4, bandwidth parts (BWPs) may be specified within the carrier bandwidth in NR so that the UE may use the same. In addition, the bandwidth part may be associated with one numerology, may include a subset of consecutive common resource blocks, and may be activated dynamically over time. The UE has up to four bandwidth parts in each of the uplink and the downlink. The UE transmits and receives data using an activated bandwidth part during a given time.

In the case of a paired spectrum, uplink and downlink bandwidth parts are configured independently. In the case of an unpaired spectrum, in order to prevent unnecessary frequency re-tuning between a downlink operation and an uplink operation, the downlink bandwidth part and the uplink bandwidth part are configured in pairs to share a center frequency.

### <Initial Access in NR>

In NR, a UE performs a cell search and a random access procedure in order to access and communicates with a base station.

The cell search is a procedure of the UE for synchronizing with a cell of a corresponding base station using a synchronization signal block (SSB) transmitted from the base station and acquiring a physical-layer cell ID and system information.

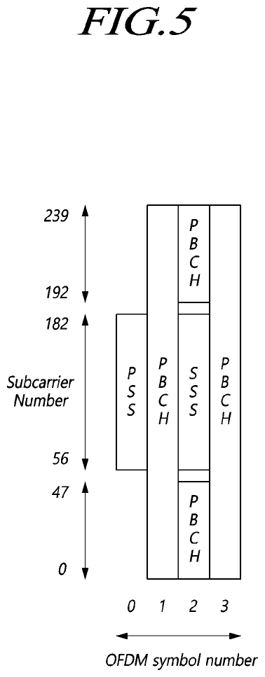

FIG. 5 illustrates an example of a synchronization signal block in a radio access technology in accordance with embodiments of the present disclosure.

Referring to FIG. 5, the SSB includes a primary synchronization signal (PSS) and a secondary synchronization signal (SSS), which occupy one symbol and 127 subcarriers, and PBCHs spanning three OFDM symbols and 240 subcarriers.

The UE monitors the SSB in the time and frequency domain, thereby receiving the SSB.

The SSB may be transmitted up to 64 times for 5 ms. A plurality of SSBs are transmitted by different transmission beams within a time of 5 ms, and the UE performs detection on the assumption that the SSB is transmitted every 20 ms based on a specific beam used for transmission. The number of beams that may be used for SSB transmission within 5 ms may be increased as the frequency band is increased. For example, up to 4 SSB beams may be transmitted at a frequency band of 3 GHz or less, and up to 8 SSB beams may be transmitted at a frequency band of 3 to 6 GHZ. In addition, the SSBs may be transmitted using up to 64 different beams at a frequency band of 6 GHz or more.

One slot includes two SSBs, and a start symbol and the number of repetitions in the slot are determined according to subcarrier spacing as follows.

Unlike the SS in the typical LTE system, the SSB is not transmitted at the center frequency of a carrier bandwidth. That is, the SSB may also be transmitted at the frequency other than the center of the system band, and a plurality of SSBs may be transmitted in the frequency domain in the case of supporting a broadband operation. Accordingly, the UE monitors the SSB using a synchronization raster, which is a candidate frequency position for monitoring the SSB. A carrier raster and a synchronization raster, which are the center frequency position information of the channel for the initial connection, were newly defined in NR, and the synchronization raster may support a fast SSB search of the UE because the frequency spacing thereof is configured to be wider than that of the carrier raster.

The UE may acquire an MIB over the PBCH of the SSB. The MIB (master information block) includes minimum information for the UE to receive remaining minimum system information (RMSI) broadcast by the network. In addition, the PBCH may include information on the position of the first DM-RS symbol in the time domain, information for the UE to monitor SIB1 (e.g., SIB1 numerology information, information related to SIB1 CORESET, search space information, PDCCH-related parameter information, etc.), offset information between the common resource block and the SSB (the position of an absolute SSB in the carrier is transmitted via SIB1), and the like. The SIB1 numerology information is also applied to some messages used in the random access procedure for the UE to access the base station after completing the cell search procedure. For example, the numerology information of SIB1 may be applied to at least one of the messages 1 to 4 for the random access procedure.

The above-mentioned RMSI may mean SIB1 (system information block 1), and SIB1 is broadcast periodically (e.g., 160 ms) in the cell. SIB1 includes information necessary for the UE to perform the initial random access procedure, and SIB1 is periodically transmitted over a PDSCH. In order to receive SIB1, the UE must receive numerology information used for the SIB1 transmission and the CORESET (control resource set) information used for scheduling of SIB1 over a PBCH. The UE identifies scheduling information for SIB1 using SI-RNTI in the CORESET. The UE acquires SIB1 on the PDSCH according to scheduling information. The remaining SIBs other than SIB1 may be periodically transmitted, or the remaining SIBs may be transmitted according to the request of the UE.

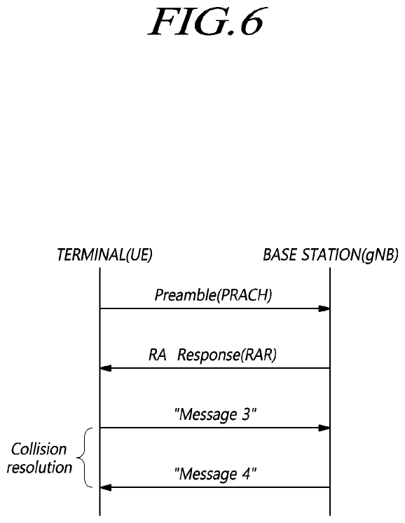

FIG. 6 is a view for explaining a random access procedure in a radio access technology to which the present embodiment is applicable.

Referring to FIG. 6, if a cell search is completed, the UE transmits a random access preamble for random access to the base station. The random access preamble is transmitted over a PRACH. Specifically, the random access preamble is periodically transmitted to the base station over the PRACH that includes consecutive radio resources in a specific slot repeated. In general, a contention-based random access procedure is performed when the UE makes initial access to a cell, and a non-contention-based random access procedure is performed when the UE performs random access for beam failure recovery (BFR).

The UE receives a random access response to the transmitted random access preamble. The random access response may include a random access preamble identifier (ID), UL Grant (uplink radio resource), a temporary C-RNTI (temporary cell-radio network temporary identifier), and a TAC (time alignment command). Since one random access response may include random access response information for one or more UEs, the random access preamble identifier may be included in order to indicate the UE for which the included UL Grant, temporary C-RNTI, and TAC are valid. The random access preamble identifier may be an identifier of the random access preamble received by the base station. The TAC may be included as information for the UE to adjust uplink synchronization. The random access response may be indicated by a random access identifier on the PDCCH, i.e., a random access-radio network temporary identifier (RA-RNTI).

Upon receiving a valid random access response, the UE processes information included in the random access response and performs scheduled transmission to the base station. For example, the UE applies the TAC and stores the temporary C-RNTI. In addition, the UE transmits, to the base station, data stored in the buffer of the UE or newly generated data using the UL Grant. In this case, information for identifying the UE must be included in the data. Lastly, the UE receives a downlink message to resolve the contention.

### <NR CORESET>

The downlink control channel in NR is transmitted in a CORESET (control resource set) having a length of 1 to 3 symbols, and it carries uplink/downlink scheduling information, an SFI (slot format index), TPC (transmit power control) information, and the like.

As described above, NR has introduced the concept of CORESET in order to secure the flexibility of a system. The CORESET (control resource set) refers to a time-frequency resource for a downlink control signal. The UE may decode a control channel candidate using one or more search spaces in the CORESET time-frequency resource. CORESET-specific QCL (quasi-colocation) assumption is configured and is used for the purpose of providing information on the characteristics of analogue beam directions, as well as delay spread, Doppler spread, Doppler shift, and an average delay, which are the characteristics assumed by existing QCL.

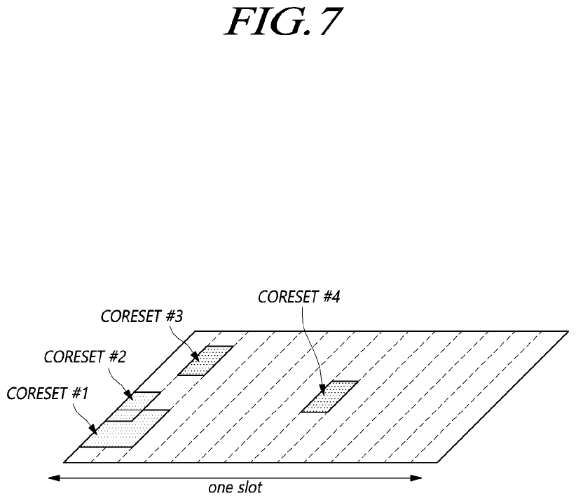

FIG. 7 illustrates CORESET.

Referring to FIG. 7, CORESETs may exist in various forms within a carrier bandwidth in a single slot, and the CORESET may include a maximum of 3 OFDM symbols in the time domain. In addition, the CORESET is defined as a multiple of six resource blocks up to the carrier bandwidth in the frequency domain.

A first CORESET, as a portion of the initial bandwidth part, is designated (e.g., instructed, assigned) through an MIB in order to receive additional configuration information and system information from a network. After establishing a connection with the base station, the UE may receive and configure one or more pieces of CORESET information through RRC signaling.

In this specification, a frequency, a frame, a subframe, a resource, a resource block, a region, a band, a subband, a control channel, a data channel, a synchronization signal, various reference signals, various signals, or various messages in relation to NR (New Radio) may be interpreted as meanings used at present or in the past or as various meanings to be used in the future.

### NR (New Radio)

The disclosure proposes a method for controlling the operation of a repeater in any cell configured by any NR base station based on the 5G mobile communication standard (i.e., NR standard) defined in 3GPP. However, the technology proposed in the disclosure is not limited to NR, and may be applied to any wireless communication technology in a substantially similar manner.

The disclosure proposes a method for detecting a user equipment (UE) in the coverage of any repeater based on a sounding reference signal (SRS), which is a reference signal defined for uplink channel sounding between the UE and a base station.

According to the typical UE SRS transmission method defined in NR, any UE supports periodic, semi-persistent, or aperiodic SRS transmission according to the base station's configuration. Specifically, periodic SRS transmission is a form of periodically transmitting SRS from the UE to the base station according to the configuration information provided by the base station. In other words, when the UE connected to any base station is configured to perform periodic SRS transmission by the base station, the UE periodically transmits an SRS based on the corresponding configuration information. Semi-persistent SRS transmission is a form of periodically transmitting an SRS similar to the periodic SRS transmission, but whether to actually transmit an SRS is determined by separate activation/deactivation indication information transmitted from the base station. In other words, the UE connected to any base station performs SRS transmission periodically when the semi-persistent SRS transmission is set up by the base station and continues transmission only when it is activated. Upon receiving deactivation indication information from the base station, the UE stops SRS transmission. In this case, the corresponding activation/deactivation indication information is delivered through media access control (MAC) control element (CE) signaling. Finally, aperiodic SRS transmission is a form in which SRS transmission is performed once at the request of the base station. In this case, the aperiodic SRS request indication information from the base station is delivered through downlink control information (DCI).

As such, NR defines three types of SRS transmission procedures. Three types of SRS transmission may be configured for any UE. For each type of SRS transmission-periodic, semi-persistent, or aperiodic—the SRS resource set configuration includes the transmission type along with SRS resource allocation information (e.g., periodicity, offset, SRS sequence, and comb allocation information) This corresponding SRS resource set information is transmitted from the base station to the UE through higher layer signaling.

As described above, SRS transmission in a UE is performed through SRS resource set configuration information from the base station (in the case of periodic SRS transmission), or through additional explicit signaling together with the corresponding SRS resource set setting. In this context, explicit signaling includes: 1. activation/deactivation signaling via MAC CE signaling in the case of semi-persistent SRS transmission; and 2. SRS request signaling via DCI in the case of aperiodic SRS transmission.

### Network-Controlled Repeater (NCR)

Coverage is a fundamental aspect of cellular network deployment. Various types of network nodes are deployed to provide comprehensive coverage. New types of network nodes have been considered to increase network deployment flexibility. For example, integrated access and backhaul (IAB) has been introduced as a new type of network node that does not require wired backhaul. Further, RF repeaters have been introduced to simply amplify and retransmit all signals received from various network nodes. RF repeaters have been widely deployed to complement the coverage provided by regular full-stack cells in 2G, 3G and 4G. RF repeaters provide a cost-effective means of expanding network coverage, but they have limitations. RF repeaters simply perform amplification and forwarding operations without considering various factors that may enhance performance.

In contrast, network-controlled repeaters have enhanced the ability to receive and process side control information in the network than conventional RF repeaters. Side control information allows the network-controlled repeater to perform amplification and transmission operations in a more efficient manner. Using this, unnecessary noise amplification mitigation, better spatial direction transmission and reception, simplified network integration, or the like may be achieved. In the disclosure, the network-controlled repeater may also be referred to as a repeater, a smart repeater, or an NCR, and the technical spirit of the disclosure is not limited by specific terms.

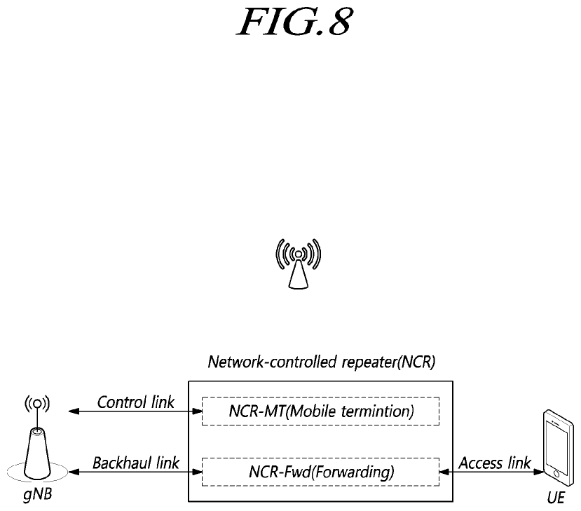

The network-controlled repeater is modeled as illustrated in FIG. 8, including two functional entities: NCR-MT (mobile termination) and NCR-Fwd (forwarding). NCR-MT is defined as a functional entity that communicates with a base station through a control link to enable the exchange of information, e.g., side control information for control of NCR-Fwd. The control link (C-link) is based on the NRUu interface. NCR-Fwd is defined as a functional entity that amplifies and delivers UL/DLRF signals between base stations and UE through the backhaul link and access link. The operation of the NCR-Fwd is controlled according to the side control information received from the base station.

The side control information may include beam information, timing information, information about the UL-DL TDD configuration, ON-OFF information, power control information, and similar parameters.

Regarding beam information, in the case of the backhaul link and the C-link both a fixed beam and an adaptive beam may apply. If the carrier of NCR-MT is within the set of carriers delivered by NCR-Fwd, then the same TCI state as the C-link is basically assumed for the beam of NCR-Fwd for the backhaul link. For DL/UL of the backhaul link in NCR-Fwd, the same beam correspondence assumption as that used for the DL/UL of the C-link in NCR-MT is applied.

In the case of an access link, at least in the case of FR2, the beam information is side control information for the network-controlled repeater and is useful, at least, for controlling the operation of the NCR for the access link. Beam correspondence is assumed for DL/UL of the access link in NCR-Fwd. The access link beam is indicated by the beam index or the index of the source RS. Both dynamic and semi-static indication methods may be applied to the beam of the access link for the NCR-Fwd.

Regarding the timing information, the DL reception timing of the NCR-Fwd matches the DL reception timing of NCR-MT. The UL transmission timing of NCR-Fwd matches the UL transmission timing of NCR-MT. The existing UE mechanism may be applied to DL/UL timing for NCR-MT.

Regarding information about UL-DL TDD configurations, at least semi-static TDD UL/DL configurations are applied to network-controlled repeaters for links including C-links, backhaul links, and access links. The same TDD UL/DL configuration is always assumed for backhaul links and access links. Further, if NCR-MT and NCR-Fwd are in the same frequency band, the same TDD UL/DL configuration is assumed for C-links, backhaul links, and access links.

Regarding the ON-OFF information, it is used to control the operation of NCR-Fwd in the network-controlled repeater. For the ON-OFF information from the base station to the NCR to control the operation of NCR-Fwd, the on-off state may be explicitly indicated through dynamic or semi-static signaling, or an on-off pattern such as new DRX-like pattern, may be explicitly indicated. Alternatively, it may be implicitly indicated through signaling for other information such as a beam, a DL/UL configuration, or PC information.

Both dynamic and semi-static indications may be applied for NCR-Fwd ON-OFF indications to enable efficient interference management and enhance energy efficiency.

The disclosure proposes a method for controlling a repeater by a base station in a wireless mobile communication system. In particular, a method is proposed for the base station to detect a UE in the repeater coverage for the purpose of minimizing repeater power and optimizing repeater beams for the UE.

Hereinafter, a method of performing wireless communication using a repeater is described in detail with reference to the related drawings.

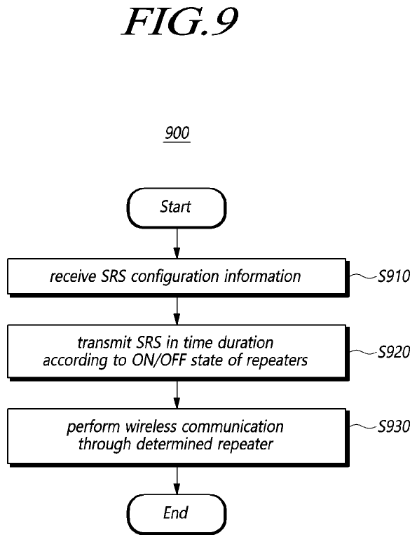

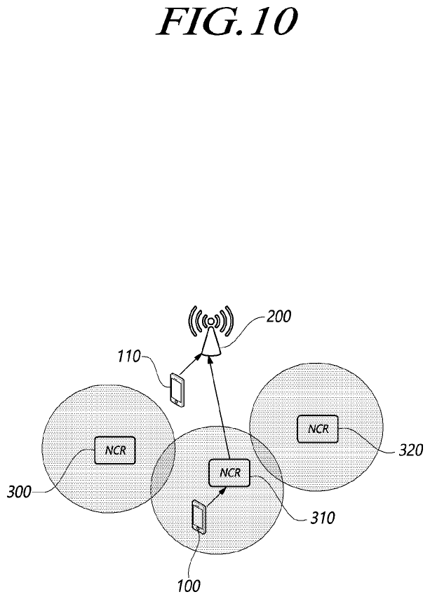

FIG. 9 is a flowchart illustrating a procedure 900 of performing wireless communication using a repeater by a UE according to an embodiment. FIGS. 10 to 12 are views illustrating determining a repeater located in coverage by a UE according to embodiments.

Referring to FIG. 9, the UE may receive configuration information for a sounding reference signal (SRS) from the base station (S910).

The UE may receive configuration information for the SRS, including information on the SRS resource set used for transmission of the SRS through higher layer signaling. The configuration information for the SRS may include i) resource allocation information, such as transmission period, offset, sequence, and ii) comb information for the SRS. Further, the configuration information for the SRS may include SRS transmission type information corresponding to the corresponding SRS resource set and similar parameters. The SRS transmission type information includes the periodic, semi-persistent, or aperiodic SRS transmission type.

Referring back to FIG. 9, the UE may transmit the SRS to the base station in each of sequential time durations according to ON/OFF states of the multiple repeaters based on the SRS configuration information (S920).

The UE may transmit the SRS to the base station based on the SRS resource allocation information and the SRS transmission type information for the SRS resource set included in the configuration information for the SRS. In other words, in the case of a periodic the SRS transmission type, the UE may periodically transmit the SRS according to the configuration information about the SRS. Alternatively, in the case of the semi-persistent the SRS transmission type, the UE may periodically transmit the SRS when the SRS transmission is activated by MAC CE signaling and may stop the SRS transmission when deactivated. Alternatively, in the case of an aperiodic the SRS transmission type, when a request from the base station is received through DCI, the UE may perform the SRS transmission.

For coverage expansion, at least one repeater having predetermined coverage may be included in coverage of the base station. In this case, the repeater may be a network-controlled repeater (NCR) whose operation is controlled based on side control information (SCI) from the base station.

The repeater performs the operation of forwarding the uplink signal of the UE to the base station and transferring the downlink signal of the base station to the UE in the ON state. Further, the repeater does not perform any signal forwarding between the base station and the UE in the OFF state. Under the control of the base station, the repeater may alternately perform the ON state operation and the OFF state operation.

According to an embodiment, the base station may control the repeater to transmit at least one SRS in each of the ON state time duration and the OFF state time duration of the repeater based on the time domain resource allocated to the SRS transmission included in the configuration information for the SRS. However, this is just one example, and the disclosure is not limited thereto. The base station may determine a time domain resource allocated to the SRS transmission so that at least one SRS is transmitted during each of the predetermined ON state and OFF state time durations of the repeater.

According to an embodiment, referring to FIG. 10, three repeaters 300, 310, and 320 that are communicatively connected to the base station 200 are illustrated. For convenience of description, three repeaters are shown, but this is an example, and the disclosure is not limited thereto. Naturally, the number of the repeaters may be set to differ, and even in this case, the technical spirit of the disclosure may be applied in substantially the same manner.

In the case of the UE 100 located in the coverage of the repeater 310, the repeater 310 may transfer the SRS transmitted by the UE to the base station. Alternatively, the UE 110 not located in the coverage of the repeaters is directly connected to the base station, and the SRS from the UE 110 may be transmitted directly to the base station 200.

In this case, if the base station may not identify the repeater 310 that transfers the SRS transferred from the UE 100 to the base station among the repeaters, the base station controls all of the repeaters in the base station coverage to operate in an ON state for the SRS transmission of the UE 100. Accordingly, power is wasted on the unnecessary repeaters 300 and 320 when the SRS of the UE 100 is transferred.

Therefore, it is necessary for the base station to specify the repeater 310 as the repeater that transfers the SRS transmitted from the UE 100 to the base station among the repeaters. To that end, first, it is necessary to determine whether the UE transmitting the SRS is located in the coverage of the repeaters or is directly connected to the base station.

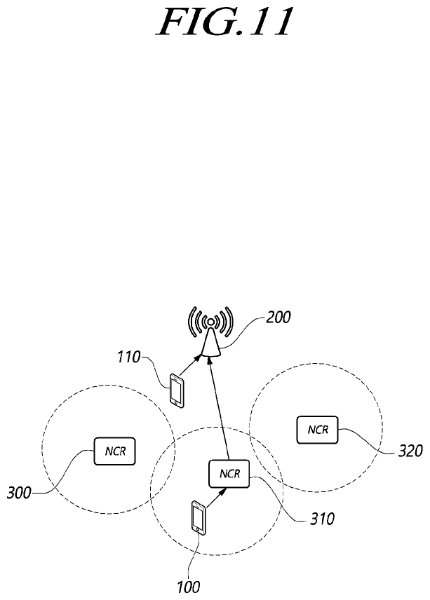

According to an embodiment, the UE may be determined to be located within the coverage of the repeaters if the difference between the strength of the SRS received by the base station when the repeaters are in the ON state and the strength of the SRS received by the base station when the repeaters are in the OFF state is greater than a predetermined threshold. In other words, first, as illustrated in FIG. 10, all of the repeaters may be operated in the ON state for the SRS transmission of a UE. The SRS transmitted by the UE is received by the base station, and the base station may measure an uplink channel state such as a received power intensity and an RSRP value for the SRS transmission. Hereinafter, as illustrated in FIG. 11, all of the repeaters may be operated in the OFF state for the SRS transmission of the same UE. Similarly, the base station may measure an uplink channel state such as a received power intensity, an RSRP value, or the like with respect to the SRS transmission.

When the OFF state measurement value for the SRS decreases by more than a predetermined threshold compared to the ON state measurement value for the SRS, the corresponding UE may be determined as the UE 100 located in the coverage of the repeaters.

For example, referring to FIGS. 10 and 11, in the case of a UE 110 that is directly connected to the base station and located outside the coverage of the repeaters, the SRS is directly transmitted to the base station regardless of the ON/OFF state of the repeaters. Therefore, the ON state and OFF state measurement values for the SRS have approximately equal values. On the other hand, in the case of the UE 100 located in the coverage of the repeaters, the SRS is transferred to the base station by the repeater in the ON state of the repeaters, but the SRS is received directly from the base station in the OFF state. Therefore, the ON state and OFF state measurement values for the SRS are significantly different. Using these features, the base station may determine that the corresponding UE is located in the coverage of the repeaters when the difference between the ON state measurement value for the SRS and the OFF state measurement value for the SRS is larger than the threshold.

As described above, when it is determined that the UE 100 is located within the coverage of the repeaters 300, 310, and 320, the base station may control each of the repeaters to be sequentially turned on/off in order to specify the repeater 310 transferring the SRS of the corresponding UE 100 among the repeaters. In other words, once it is confirmed that the UE is within repeater coverage, the specific repeater covering the UE may be identified based on the strength of the SRS received by the base station while each of the repeaters is individually switched on/off.

For example, for the SRS transmitted by the UE 100, the base station may control the repeater 300 to be turned on, while controlling the other repeaters 310 and 320 to be turned off. Next, the base station may turn on repeater 310 and turn off repeaters 300 and 320. Finally, the base station may turn on repeater 320 and turn off repeaters 300 and 310.

As illustrated in FIG. 10, the UE 100 is located within the coverage of the repeater 310. Therefore, when only the repeater 300 is in the ON state and the repeater 310 is in the off state, the SRS of the UE 100 is directly transmitted to the base station. Subsequently, when only the repeater 310 is in the ON state, the SRS of the UE 100 is transferred to the base station through the repeater 310. Then, when only the repeater 320 is in the ON state, the repeater 310 is in the OFF state, and thus the SRS of the UE 100 is directly transmitted to the base station. Therefore, the strength of the SRS of the UE 100 is measured as highest when only the repeater 310 is in the ON state. Accordingly, the base station may determine that the UE 100 is located in the coverage of the repeater 310.

According to an embodiment, when it is determined that the UE is included in the coverage of the repeaters, the repeater group including the repeater having the UE located in its coverage may be determined based on the strength of the SRS received by the base station in a state in which each of a plurality of repeater groups of the repeaters is sequentially turned on/off. In this case, the repeater determined to have the UE located in its coverage may be determined based on the strength of the SRS received by the base station in a state in which each repeater included in the determined repeater group is sequentially turned on/off.

For example, it is assumed that the repeaters 300, 310, and 320, illustrated in FIG. 10, are grouped into a first group including one repeater 300 and a second group including two repeaters 310 and 320. First, the base station may sequentially turn the first group and the second group ON and OFF. When only the first group is in the ON state (i.e., when only the repeater 300 is in the ON state), the repeater 310 is in the OFF state, and thus the SRS of the UE 100 is directly transmitted to the base station. Next, when only the second group is in the ON state (i.e., when the repeater 310 and the repeater 320 are in the ON state), the SRS of the UE 100 is transferred to the base station through the repeater 310. Accordingly, the strength of the SRS of the UE 100 is measured as highest when only the second group is in the ON state. Based on this, the base station may determine that the UE 100 is located within the coverage of the repeater 310 or the repeater 320 included in the second group.

In this case, the base station may sequentially control the repeater 310 and repeater 320 in the second group. In other words, when only the repeater 310 is in the ON state, the SRS of the UE 100 is transferred to the base station through the repeater 310. Subsequently, when only the repeater 320 is in the ON state and the repeater 310 is in the OFF state, the SRS of the UE 100 is directly transmitted to the base station. Therefore, the strength of the SRS from the UE 100 is measured as highest when only the repeater 310 is in the ON state. Accordingly, the base station may determine that the UE 100 is located in the coverage of the repeater 310.

In the above description, it has been described that one of the groups is determined first, and then a repeater within the corresponding group is determined second. However, the disclosure is not limited thereto. In other words, the technical spirit of this disclosure may be applied in substantially the same manner to methods that divide repeaters based on any N-order hierarchical structure, such as determining one group among multiple groups, and then regrouping that group to determine a specific repeater.

According to another embodiment, the repeater determined to have the UE located in its coverage may be determined based on the sequence applied to the SRS received by the base station among the sequences configured differently for each of the repeaters.

To that end, the base station may allocate sequence values such as cyclic shift values or phase rotation/shift values to be masked when delivering the corresponding SRS for each repeater. In this case, the time domain resource information and frequency domain resource information where SRS transmission of the UE marked to perform relaying by the repeater may be configured through higher layer signaling by the base station or be indicated through the side control information (SCI).

The base station may identify the sequence applied to the received SRS and determine that the UE is located within the coverage of the repeater to which the sequence is allocated. In this case, according to an example, the process of determining whether the UE is located in the coverage of the repeaters based on the ON/OFF control of all repeaters, as described above, may be skipped.

Referring back to FIG. 9, the UE may perform wireless communication with the base station through the repeater determined to have the UE located in its coverage based on the transmitted SRS (S930).

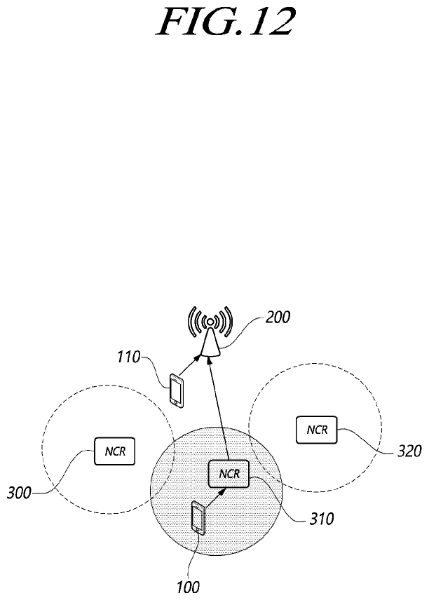

As described above, it is assumed that the UE 100 is determined to be located within the coverage of the repeater 310. In this case, as illustrated in FIG. 12, the base station may control only the repeater 310 to be turned on, and control the other repeaters 300 and 320 to be turned off during subsequent signal transmission/reception with the UE.

According to the embodiments described above, wireless communication may be performed using a repeater in a wireless network. Further, by controlling only the necessary repeater to operate and disabling the relaying operation of unnecessary repeaters, it is possible to reduce radio signal interference and power consumption of the repeater.

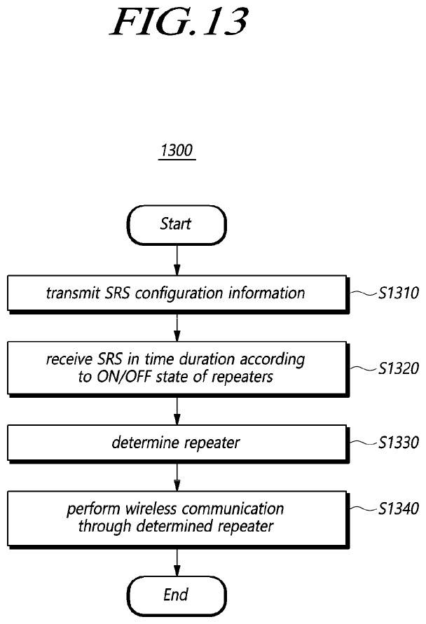

FIG. 13 is a flowchart illustrating a procedure 1300 of performing wireless communication using a repeater by a base station according to an embodiment. In FIG. 9 to FIG. 12, the above description may be omitted to avoid duplicate descriptions. In such cases, the omitted description may be applied in substantially the same manner to the base station, unless they contradict the technical spirit of the disclosure.

Referring to FIG. 13, the base station may transmit configuration information for a sounding reference signal (SRS) to the UE (S1310).

The base station may transmit the configuration information for the SRS including information on the SRS resource set used for transmission of the SRS to the UE through higher layer signaling. The configuration information for the SRS may include i) resource allocation information such as transmission period, offset, sequence, and ii) comb information about the SRS. Further, the configuration information for the SRS may include SRS transmission type information corresponding to the corresponding SRS resource set or the like. The SRS transmission type information includes the periodic, semi-persistent, or aperiodic SRS transmission type.

Referring back to FIG. 13, the base station may receive (S1320), from the UE, an SRS in each of sequential time durations according to the ON/OFF states of repeaters based on configuration information about the SRS and determine (S1330) a repeater having the UE located in the coverage among the repeaters.

The base station may receive the SRS from the UE based on the SRS resource allocation information and the SRS transmission type information about the SRS resource set included in the configuration information for the SRS. In other words, in the case of the periodic SRS transmission type, the base station may periodically receive the SRS according to the configuration information for the SRS. Alternatively, in the case of the semi-persistent SRS transmission type, the base station may periodically receive the SRS when the SRS transmission is activated by MAC CE signaling. Alternatively, in the case of the aperiodic SRS transmission type, the base station may transmit a request through DCI and perform SRS reception.

According to an embodiment, the base station may control the repeater to transmit at least one SRS in each of the ON state time duration and the OFF state time duration of the repeater based on the time domain resource allocated to the SRS transmission included in the configuration information for the SRS. However, this is merely an example, and the disclosure is not limited thereto. The base station may alternatively determine the time domain resource allocated to the SRS transmission such that at least one SRS is transmitted during each predetermined ON and OFF state time duration of the repeater.

Referring to FIG. 10, in the case of the UE 100, which is located within the coverage of the repeater 310, the repeater 310 may transfer the SRS transmitted by the UE to the base station. Alternatively, the UE 110, which is not located within the coverage of the repeaters, is directly connected to the base station, and the SRS from the UE 110 may be directly received by the base station 200.

According to an embodiment, the UE may be determined to be located within the coverage of the repeaters if the difference between the strength of the SRS received by the base station when the repeaters are in the ON state and the strength of the SRS received by the base station when the repeaters are in the OFF state is greater than a predetermined threshold. In other words, as illustrated in FIG. 10, all repeaters may first be operated in the ON state for the SRS transmission of any UE. The SRS transmitted by the UE is received by the base station, which may measure an uplink channel state such as a received power intensity and an RSRP value. Then, as illustrated in FIG. 11, all repeaters may be operated in the OFF state for the SRS transmission of any UE. Similarly, the base station may measure an uplink channel state such as a received power intensity, an RSRP value, or the like for the SRS transmission.

When the OFF state measurement value for the SRS decreases by more than a predetermined threshold compared to the ON state measurement value, the corresponding UE may be determined to be the UE 100, located within the coverage of the repeaters.

For example, referring to FIGS. 10 and 11, in the case of a UE 110, which is directly connected to the base station and located outside the coverage of the repeaters, the SRS is directly transmitted to the base station regardless of the ON/OFF state of the repeaters. Therefore, the ON state and OFF state measurement values for the SRS are approximately equal. On the other hand, in the case of the UE 100, located within the coverage of the repeaters, the SRS is transferred to the base station by a repeater when the repeaters are in the ON state, but the SRS is received directly by the base station in the OFF state. Therefore, the ON state and OFF state measurement values for the SRS are significantly different. Using these characteristics, the base station may determine that the corresponding UE is located within the coverage of the repeaters when the difference between the ON state and OFF state measurement values for the SRS exceeds a predefined threshold.

As described above, when it is determined that the UE 100 is located within the coverage of the repeaters 300, 310, and 320, the base station may control each repeater to be sequentially turned on and off in order to identify the repeater 310 as the one transferring the SRS of the UE 100. In other words, once the UE is determined to be withing repeater coverage, the specific repeater serving the UE may be identified based on the strength of the SRS received by the base station while each repeater is sequentially turned on and off.

For example, for the SRS transmitted by the UE 100, the base station may first control the repeater 300 to be turned on, while turning OFF repeaters 310 and 320. Next, the base station may turn on the repeater 310 and turn off the other repeaters 300 and 320. Finally, the base station may turn on the repeater 320 and turn off the other repeaters 300 and 310.

As illustrated in FIG. 10, the UE 100 is located within the coverage of the repeater 310. Therefore, when only the repeater 300 is in the ON state and the repeater 310 is in the OFF state, the SRS of the UE 100 is directly received by the base station. Next, when only the repeater 310 is in the ON state, the SRS of the UE 100 is transferred to the base station through the repeater 310. Then, when only the repeater 320 is in the ON state and the repeater 310 is in the OFF state, the SRS of the UE 100 is directly transmitted to the base station. Therefore, the strength of the SRS of the UE 100 is measured as highest when only the repeater 310 is in the ON state. Accordingly, the base station may determine that the UE 100 is located within the coverage of the repeater 310.

According to an embodiment, when it is determined that the UE is included in the coverage of the repeaters, the repeater group including the repeater that has the UE within its coverage may be identified based on the strength of the SRS received by the base station while each of a plurality of repeater groups is sequentially turned on and off. In this case, the specific repeater that has the UE within its coverage may be determined based on the strength of the SRS received by the base station while each repeater within the identified repeater group is sequentially turned on and off.

For example, it is assumed that the repeaters 300, 310, and 320, as illustrated in FIG. 10, are grouped into a first group including one repeater 300 and a second group including two repeaters 310 and 320. First, the base station may sequentially turn the first group and the second group ON and OFF. When only the first group is in the ON state (e.g., when only the repeater 300 is in the ON state), the repeater 310 is in the OFF state, and thus the SRS of the UE 100 is directly transmitted to the base station. Next, when only the second group is in the ON state (i.e., when the repeater 310 and the repeater 320 are in the ON state), the SRS of the UE 100 is transferred to the base station through the repeater 310. Accordingly, the strength of the SRS of the UE 100 is measured as highest when only the second group is in the ON state. Based on this, the base station may determine that the UE 100 is located within the coverage of either repeater 310 or repeater 320 in the second group.

In this case, the base station may sequentially control the repeater 310 and the repeater 320 in the second group. In other words, when only the repeater 310 is in the ON state, the SRS of the UE 100 is transferred to the base station through the repeater 310. Subsequently, when only the repeater 320 is in the ON state and the repeater 310 is in the OFF state, the SRS of the UE 100 is directly transmitted to the base station. Therefore, the strength of the SRS from the UE 100 is measured as highest when only the repeater 310 is in the ON state. Accordingly, the base station may determine that the UE 100 is located within the coverage of the repeater 310.

According to another embodiment, the repeater determined to have the UE located in its coverage may be identified based on the sequence applied to the SRS received by the base station, among the sequences configured differently for each repeater.

To that end, the base station may allocate sequence values, such as cyclic shift values or phase rotation/shift values, to be masked when delivering the corresponding SRS for each repeater. In this case, the time domain resource information and frequency domain resource information, where the SRS transmission of the UE marked for relaying by the repeater occurs, may be configured through higher layer signaling by the base station or indicated through the side control information (SCI).

The base station may identify the sequence applied to the received SRS and determine that the UE is located within the coverage of the repeater to which the sequence is allocated. In this case, according to an example, a process of determining that the UE's location based on ON/OFF control of all repeaters, as described above, may be unnecessary.

Referring back to FIG. 13, the base station may perform wireless communication with the UE through the determined repeater (S1340).

As described above, it is assumed that the UE 100 is determined to be located within the coverage of the repeater 310. In this case, as illustrated in FIG. 12, the base station may control only repeater 310 to be turned on and control the other repeaters 300 and 320 to be turned off during subsequent signal transmission/reception with the UE.

According to the embodiments described above, wireless communication may be performed using a repeater in a wireless network. Further, by controlling only the necessary repeater to operate and disabling the relaying operation of the unnecessary repeater's, it is possible to reduce radio signal interference and power consumption of the repeater.

Hereinafter, embodiments related to the method for performing wireless communication using a repeater will be described below in detail with reference to related drawings.

The disclosure proposes a method in which, as described above, the base station arbitrarily controls the relaying operation of a repeater during SRS transmission by the UE and detects the presence of a UE within the coverage of the repeater accordingly.

Specifically, the repeater may alternately perform relaying on and relaying off operations for SRS transmissions of any UE. Based on this, the base station may determine whether the UE is within the coverage of a specific repeater or whether relaying by that specific repeater is required.

Here, the relaying ON operation refers to an operation in which the repeater performs its own relaying function, i.e., transferring the uplink signal from the UE to the base station and transferring the downlink signal from the base station to the UE. Conversely, the relaying OFF operation refers to a state in which the repeater does not perform its own relaying function, i.e., a mode in which the operation of receiving the downlink signal of the base station and transmitting it to the UE and the operation of receiving the uplink signal of the UE and transmitting it to the base station are not performed. The operation may be performed by turning off the power of the entire repeater or partially turning off only the power of wireless transmission/reception-related devices in the repeater. Alternatively, it may be implemented by simply refraining from performing the corresponding radio transmission/reception functions. However, in such cases, the technical spirit of the disclosure is not limited by the specific status of the repeater during the relaying OFF period.

For the operation proposed in the disclosure, any base station may define the following three steps for detecting repeater coverage for a given UE.

Step 1 Relaying ON: A step in which all repeaters perform relaying to the base station during the SRS transmission of a UE.

Step 2—Relaying OFF: A step in which none of the repeaters perform relaying to the base station during the SRS transmission of a UE.

Step 3—Coverage Detection: A step for determining whether a UE is located within the coverage of any repeater.

Step 3-1—Sequential ON/OFF Switching: A step in which each repeater or repeater group in the cell alternates between relaying ON and OFF states during the SRS transmission of a UE.

Step 3-2—Sequence-Based Relaying: A step in which each repeater performs relaying for the SRS transmission of a UE using uniquely masked sequence assigned to that repeater.

Step 1 is a step for measuring the channel state of the UE when all repeaters perform normal relaying operations within the cell configured by any base station, and this measurement is used as a reference value. In other words, the base station receives the SRS signal from the base station to measure the channel state, based on the SRS transmission of the UE when both the base station and all the repeaters in the cell are operating normally, i.e., when full coverage is provided.

Step 2 is a step for measuring the channel state by receiving the SRS signal from the UE when cell coverage is provided only by the base station. In other words, all repeaters are turned OFF, and the base station directly receives the UE's SRS transmission to measure the uplink channel state.

The base station may compare the channel state measurement values of Step 1 and Step 2 to determine whether the UE is within the repeater coverage or is directly connected to the base station. For example, if the drop in the measurement value from Step 2 relative to that from Step 1 exceeds a predetermined threshold, the UE may be determined to be within the repeater coverage. Here, the measured value may be, e.g., the received power intensity for the UE's SRS transmission, the RSRP value, or similar channel quality indicators.

When it is determined that a UE is located within the repeater coverage through the process up to Step 2, the base station may proceed to perform the operation corresponding to Step 3.

In Step 3, as described above, Step 3-1-based operation for identifying the repeater covering the UE, based on the relaying on/off operation of each repeater. Step 3-2 step-based operation of identifying the repeater by applying a masked sequence unique to each repeater during the UE's SRS transmission.

Specifically, according to the method of Step 3-1, each repeater is 1:1 mapped to the SRS transmission of the UE, such that only the repeater mapped to a give SRS transmission performs relaying (e.g., operates in the relaying ON state), while the remaining repeaters do not perform relaying (i.e., relaying off operation). For example, for any UE, the base station may allow only one specific repeater to perform relaying for each SRS transmission—regardless of whether it is periodic, semi-persistent, or aperiodic. This operation may be carried out such that all repeaters in the cell sequentially and alternately relay the respective SRS transmissions.

As another method under Step 3-1, instead of performing a 1:1 mapping between a repeater and each UE SRS transmission, a repeater group may first be mapped to the UE, primarily identifying the repeater group in which the UE is located. Then, secondarily, the individual repeater within that group may be identified as each repeater in the group sequentially relays the UE's SRS transmission. In other words, a hierarchical identification method may be applied, where the repeater group is identified first, followed by the individual repeater. Although the above-described example is based on a two-level hierarchical structure, any N-order hierarchical repeater identification method may similarly fall within the scope of the disclosure in the same manner.

The method proposed in the 3-2nd step is described below.

By masking and relaying a separate sequence for each repeater for the SRS transmission of the UE, the SRS that is relayed through a specific repeater may be identified by the base station. Specifically, in NR, the SRS of the UE is generated and transmitted using a Zadoff-Chu sequence. Zadoff-Chu sequences are orthogonal to one another when different phase rotations are applied along the frequency axis, depending on the sequence length and the M value (which means a cyclic shift on the time axis). Accordingly, if a UE applies a different phase rotation to the Zadoff-Chu sequence used for its SRS—based on a common root sequence—corresponding to each repeater, and transmits the SRS accordingly, the base station may identify which repeater relayed the SRS based on the detected sequence characteristics.

To that end, the base station may allocate a sequence value (e.g., a cyclic shift value or a phase rotation/shift value) to be masked when each repeater performs SRS relaying. Sequence allocation information about each repeater may be delivered through higher layer signaling or indicated via side control information (SCI). Along with the sequence allocation information, the base station may also configure or indicate the SRS transmission resources of the UE that should be masked and relayed based on the allocated sequence for each repeater. In other words, the time domain and frequency domain resource information used for the UE's SRS transmission, where masking and relaying by a specific repeater are to be applied, may be configured by the base station through higher layer signaling or indicated via SCI.

A specific method for masking a separate sequence for each repeater—enabling identification of the repeater—has been provided above, but the disclosure is not limited thereto. Any case in which a specific code or sequence is masked to the signal of the UE for each repeater, not limited to the SRS, and transferred to the base station such that the base station may identify the repeater that relayed the UE's signal, may also fall within the scope of the disclosure.

Further, in this disclosure, ‘repeater’ may include all entities that transfer wireless signals between a base station and a UE, such as reconfigurable intelligent surfaces (RIS), which are discussed as next-generation repeater types, as well as optical repeaters or RF repeaters.

A method for identifying the repeater covering the UE by defining how a repeater relays the UE's SRS transmission has been proposed above. Accordingly, the base station may control only the necessary repeater to operate when transmitting data to the UE, thereby eliminating relaying operations of unnecessary repeaters and reducing both the power consumption and radio signal interference.

In the case of any cell/base station operating in a high frequency band, such as frequency range 2 (FR2) of 5G, a hybrid beamforming method that combines analog and digital beamforming technologies is applied to expand radio coverage. Accordingly, it is necessary to enhance the coverage and data transmission/reception performance of the repeater by selecting and transmitting the optimal Tx beam through analog beamforming, based on the UE's location or channel state.

In the disclosure, for convenience of description, the link between the base station and the repeater used to control the repeater is referred to as a C-link. On the other hand, the link between the repeater and the UE, used to perform the repeater's primary function, i.e., amplifying and forwarding the downlink signal from the base station to the UE and the uplink signal from the UE to the base station, is referred to as the F-link. Referring to FIG. 8, the C-link corresponds to the link (c) between the base station and the repeater, while the F-link includes link (b) between the base station and the repeater and the link (a) between the repeater and the UE. However, these link names are provided as an example and as not intended to limit the scope of the disclosure.

The base station may transmit control information about the Tx beam or the Rx beam for a given repeater to the corresponding repeater via the C-link. In this disclosure, such control information transmitted from the base station to the repeater is referred to as side control information (SCI).

Based on the SCI received from the base station, the repeater may configure a DL Tx beam to amplify and forward the signal of the base station via the F-link or a UL Rx beam to receive the uplink signal from the UE.

Hereinafter, a method of controlling DL Tx beam or UL Rx beam for the F-link is proposed. However, the technical spirit of the disclosure may also be applied to the transmission and reception of the original signal used for amplification and forwarding between the base station and the repeater, whether through C-link control for SCI transmission or F-link.

According to an embodiment, a repeater may report the number of downlink transmission (DL Tx) beams it supports to the base station or network, either through a capability signaling or pre-configured manner. In this case, beam indexing may be applied to each DL Tx beam based on the total number of DL Tx beams supported. In other words, if a repeater supports N DL Tx beams, beam indexes (or beam IDs) from 0 to N−1 may be assigned to the respective DL Tx beams.

However, the DL Tx beam supported by a repeater may be classified into one or more types based on the cast type. For example, a repeater may support three types of DL Tx beams: i) type 1 DL Tx beam(s) for broadcast: ii) type 2 DL Tx beam(s) for multicast/groupcast; and iii) type 3 DL Tx beam(s) for unicast. Alternatively, two types of DL Tx beams may be defined, such as: i) type 1 DL Tx beam(s) for broadcast/multicast/groupcast; and ii) type 2 DL Tx beam(s) for unicast.

Similarly, a repeater may deliver information about the number of Rx beams supported by the repeater to the base station/network through capability signaling or pre-configured methods. In this case, beam indexing is performed for each UL Rx beam based on the total number of UL Rx beams supported by the repeater. In other words, if a repeater supports M UL Rx beams, beam indexes (or beam IDs) of 0, 1, 2, . . . , M−1 may be assigned for each UL Rx beam supported by the repeater. However, according to an example, UL Rx beams may not be assigned separately. Instead, they may be defined by pairing with the DL Tx beam indexes (or beam IDs). In other words, if a repeater supports N DL Tx beams, it may also support N UL Rx beams for UL Rx, and the DL Tx/UL Rx beam pairs may be indexed jointly as 0, 1, 2, . . . , N−1.

The base station may transmit control information about the Tx beam or the Rx beam for a given repeater to the corresponding repeater. The DL Tx beam or UL Rx beam of the repeater may be indicated by the base station through the SCI. In this case, the beam indication information used to identify the beam of the repeater may be classified into two types: dynamic beam indication information; and semi-static (or periodic or semi-persistent) beam indication information.

A dynamic beam set and a semi-static beam set supported by a repeater may be configured separately. In other words, the dynamic DL Tx beam set and dynamic UL Rx beam set may be configured independently from the semi-static DL Tx beam set and semi-static UL Rx beam set. To that end, the identification of the DL Tx beam or UL Rx beam type supported by the repeater may be applied to DL or UL beam set configurations subject to dynamic beam identification and DL and UL beam set configurations subject to semi-static beam identification. For example, based on the cast type, type 1 DL Tx beam or UL Rx beam for broadcast and multicast/groupcast may belong to a semi-static beam set, while type 2 DL Tx beam or UL Rx beam for unicast may belong to a dynamic beam set. Alternatively, during repeater capability configuration, information about the dynamic DL Tx beam set and the semi-static DL Tx beam set and the dynamic UL Rx beam set and semi-static UL Rx beam set supported by the repeater, with the semi-static beam set and the dynamic beam set distinct from each other, may be transferred to the base station/network through capability signaling or be pre-configured.

Alternatively, all DL Tx beams and UL Rx beams supported by the repeater may be defined as the target beam set of either dynamic or semi-static beam indication, without a distinction between dynamic and semi-static beam sets.

### Dynamic Beam Indication Information Method

Dynamic beam indication is an event-triggered form of beam indication, in which the base station may specify the beam information to be used by the corresponding repeater for DL Tx or UL Rx during a specific time duration. To that end, the base station may deliver the dynamic beam indication information along with the corresponding time duration allocation information via SCI. In this case, the time duration indication information, such as time offset information and duration information, may be assigned for each beam indication information.

As another example, dynamic beam indication may be performed as beam change indication information in units of SCI transmission periods. In other words, for any repeater, it may be defined that the dynamic beam indication is applied on a per-SCI transmission period bases. Accordingly, the DL Tx beam or UL Rx beam to be used by the corresponding repeater may be indicated as valid until the next SCI transmission.

Specifically, it may be defined that the repeater determines a beam to be used for DL Tx and UL Rx starting from the symbol immediately following the last symbol of the current SCI transmission and continuing until the last symbol before the next SCI transmission, based on the DL Tx beam indication information or UL Rx beam indication information provided during the SCI transmission. Alternatively, an SCI processing time or maximum SCI processing time, T_{proc} in the repeater may be defined to determine a beam to be used during DL Tx and UL Rx from the first symbol after the last symbol+T_{proc} where the SCI transmission is performed to the last symbol belonging to the last symbol+T_{proc} where the next SCI transmission is performed. Alternatively, it may be defined to determine a beam to be used during DL Tx and UL Rx from the first slot after the last symbol+T_{proc} where the SCI transmission is performed to the last slot belonging to the last symbol+T_{proc} where the next SCI transmission is performed.

Alternatively, it may be defined to determine a beam to be used during DL Tx and UL Rx from the next slot of the slot where SCI transmission is performed to the slot where the next SCI transmission is performed. Alternatively, it may be defined to determine a beam to be used during DL Tx and UL Rx from the slot corresponding to slot+n where the SCI transmission is performed to the slot corresponding to slot+n−1 where the next SCI transmission is performed. In this case, the corresponding n value may be indicated through SCI signaling by the base station/network, set through higher layer signaling, or pre-configured.

As another example, a time granularity for performing beam indication through a single SCI may be defined, such that DL Tx Beam or UL Rx beam indication information is transmitted for each time granularity. For example, the time granularity may be configured in slot or symbol units, and a time domain boundary for M beam identifications may be configured based on a given time granularity in any SCI transmission/reception period or monitoring period. In this case, one SCI may include DL TX beam indication information or UL Rx beam indication information for each time granularity. In other words, a single SCI may carry M pieces of beam indication information. According to an example, time granularities may be asymmetrically configured in the time domain. For example, if two time granularities are configured in a slot, they may be configured as (1 symbol, 13 symbols), (2 symbols, 12 symbols), or (3 symbols, 11 symbols). Additionally, for the time granularity configuration information for the corresponding beam indication, a single pattern may be pre-configured. Alternatively, multiple patterns may be defined, and the base station may configure or indicate the pattern to be used by the repeater via higher layer signaling or SCI.

### Semi-Static Beam Indication/Setting Method

A semi-static beam indication is a type of repeated beam indication or setting based on predetermined cycles. A DL Tx beam to be used for DL Tx or a UL Rx beam to be used for UL Rx may be indicated or set at predetermined cycles in the repeater. To that end, a semi-static beam indication or setting for any repeater may be performed by the base station, independently of the dynamic beam indication method via the SCI. The semi-static beam indication or setting (e.g., configuration) may be indicated (e.g., delivered) through an SCI that is separate from the SCI including the dynamic beam indication information. Alternatively, the semi-static beam indication or setting may be transmitted via one SCI along with the dynamic beam indication information, but indicated through a separately defined semi-static beam indication information area within the SCI distinct from the information area used for the dynamic beam indication. Alternatively, it may be configured through higher layer signaling. However, similar to dynamic beam indication information, when semi-static beam indication information is transmitted through SCI, a beam type indication information area to identify whether the beam indication information transmitted through the SCI is dynamic beam indication information or semi-static beam indication information may be additionally defined and transmitted through the SCI. Alternatively, an SCI format for the semi-static beam indication, separate from the SCI format for the dynamic beam indication, may be defined. The semi-static beam indication or configuration information may include time duration allocation information where the beam-based DL Tx or UL Rx is performed together with the DL Tx beam indication information or UL Rx beam indication information. The corresponding time duration allocation information may be composed of period information, time offset information, duration information, or the like.

Additionally, the indication or setting of dynamic and semi-static beams for any repeater may be performed based on the above-described method or another method. In such case, an overlap may occur between the dynamic beam indication and the semi-static beam indication or setting during a specific time duration. In this case, it is necessary to define which Tx or Rx beam should be used for DL Tx or UL Rx in the corresponding repeater. For example, priority may be given to the semi-static beam. In other words, when dynamic beam indication information and semi-static beam indication information overlap in the time domain for a given repeater, the repeater may prioritize the semi-static beam indication information to configure the DL Tx beam or UL Rx beam.

Alternatively, a different approach may be adopted, in which priority is given to dynamic beam indication information. When the dynamic and semi-static beam indication information overlap in time domain for a given repeater, the repeater may prioritize the dynamic beam indication information to configure DL Tx beam or UL Rx beam.

According to the embodiments described above, data transmission/reception performance and repeater coverage may be enhanced by controlling the beam information used for communication between the repeater and the UE, selecting the optimal beam based on various contextual factors, such as the UE's connection status, position, or channel state.

Hereinafter, configurations of a UE and a base station capable of performing all or some of the embodiments described above in connection with FIGS. 1 to 13 are described with reference to the drawings. The previously described content may be omitted here to avoid redundancy. In such cases, the omitted description may be applied in substantially the same manner to the following description, provided does not conflict with the technical spirit of the invention.

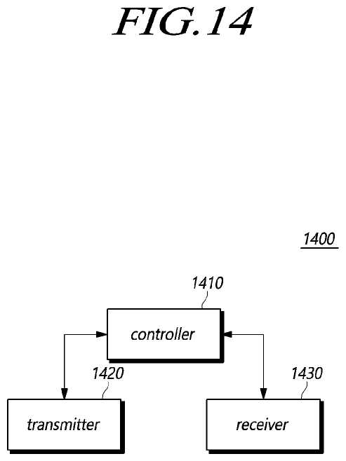

FIG. 14 is a block diagram illustrating a UE 1400 according to an embodiment.

Referring to FIG. 14, according to an embodiment, a UE 1400 includes a controller 1410, a transmitter 1420, and a receiver 1430.

The controller 1410 controls the overall operation of the UE 1400 according to a method for performing wireless communication using a repeater required to perform the present invention described above.

The controller 1410 may receive configuration information about a sounding reference signal (SRS) from the base station. The UE may receive configuration information about the SRS including information about the SRS resource set used for transmission of the SRS through higher layer signaling. The controller 1410 may transmit the SRS to the base station in each of sequential time durations according to ON/OFF states of the repeaters based on the SRS configuration information.

According to an embodiment, the base station may control the repeater to transmit at least one SRS during each of the ON state and OFF state time durations, based on the time domain resource allocated to the SRS transmission as included in the configuration information about the SRS.

For a UE located within the coverage of the repeater, the repeater may transfer the SRS transmitted by the UE to the base station. Alternatively, a UE not located within the coverage of the repeaters may be directly connected to the base station, and in that case, the SRS from the UE may be directly transmitted to the base station.

According to an embodiment, the UE may be determined to be located within the coverage of the repeaters if the difference between the strength of the SRS received by the base station when the repeaters are in the ON state and the strength of the SRS received by the base station when the repeaters are in the OFF state exceeds a predetermined threshold. In other words, all repeaters may first be operated in the ON state during the SRS transmission of any UE. The SRS transmitted by the UE is received by the base station, which may measure an uplink channel state, such as a received power intensity and an RSRP value for the SRS transmission. Subsequently, all repeaters may be operated in the OFF state during the UE's SRS transmission. Similarly, the base station may again measure an uplink channel state such as a received power intensity, an RSRP value, or the like with respect to the SRS transmission.

When the OFF state measurement value for the SRS decreases by more than a predetermined threshold compared to the ON state measurement value, the corresponding UE may be determined to be located in the coverage of the repeaters.

As such, when it is determined that the UE is located within the coverage of the repeaters, the base station may control each repeater to be sequentially turned ON and OFF in order to identify the specific repeater that is transferring the SRS of the corresponding UE. In other words, once it is confirmed that the UE is within the repeater coverage, the repeater covering the UE may be determined based on the strength of the SRS received by the base station while each repeater is sequentially turned ON and OFF.

According to an embodiment, when it is determined that the UE is within the coverage of the repeaters, the repeater group including the repeater that covers the UE may be identified based on the strength of the SRS received by the base station while each of a plurality of repeater groups is sequentially turned ON and OFF. Then, within the identified group, the specific repeater covering the UE may be determined based on the strength of the SRS received by the base station while each repeater in the group is sequentially turned ON and OFF.

According to another embodiment, the repeater determined to have the UE within its coverage may be determined based on the sequence applied to the SRS received by the base station, where different sequences are configured for each repeater.

To that end, the base station may allocate sequence values, such as cyclic shift values or phase rotation/shift values, to be masked when delivering the corresponding SRS for each repeater.

The base station may identify the sequence applied to the received SRS and determine that the UE is located within the coverage of the repeater to which the sequence was allocated. In this case, according to an example, a process of determining whether the UE is located within the repeater coverage based on the ON/OFF control of all of the repeaters, as described above, may be omitted.

The controller 1410 may perform wireless communication with the base station through the repeater that is determined to have the UE located within its coverage, based on the transmitted SRS.

As described above, it is assumed that the UE is determined to be located within the coverage of the repeater. In this case, during subsequent signal transmission and reception with the UE, the base station may control only that repeater to be in the ON state, while controlling the other repeaters to be in the OFF state.

According to the embodiments described above, wireless communication may be performed using a repeater in a wireless network. Further, by controlling only the necessary repeater to operate and removing the unnecessary repeater's relaying operation, it is possible to reduce interference of radio signals and power consumption of the repeater.

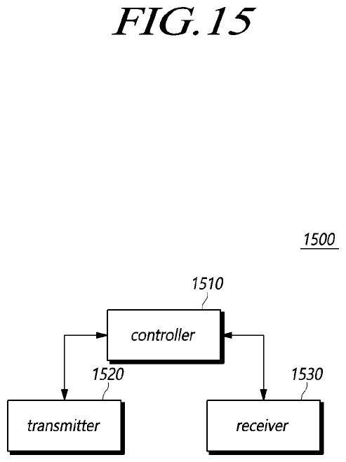

FIG. 15 is a block diagram illustrating a configuration of a base station according to an embodiment.

Referring to FIG. 15, according to an embodiment, a base station 1500 includes a controller 1510, a transmitter 1520, and a receiver 1530.

The controller 1510 controls the overall operation of the base station 1500 according to a method for performing wireless communication using a repeater required to perform the present invention described above. The transmitter 1520 performs transmission of an uplink signal from the base station or transmission of a downlink signal to the UE through a corresponding channel. The receiver 1530 performs reception of a downlink signal from the base station or reception of an uplink signal from the UE through a corresponding channel

The controller 1510 may transmit configuration information for a sounding reference signal (SRS) to the UE. The controller 1510 may transmit the configuration information for the SRS including information on the SRS resource set used for transmission of the SRS to the UE through higher layer signaling.

The controller 1510 may receive an SRS from the UE during each of sequential time durations according to the ON/OFF states of repeaters, based on the configuration information for the SRS, and may determine which a repeater has the UE located within its coverage.

According to an embodiment, the base station may control the repeater to transmit at least one SRS during each of the ON state and OFF state time durations of the repeater, based on the time domain resource allocated for SRS transmission as specified in the configuration information for the SRS.

According to an embodiment, the UE may be determined to be located within the coverage of the repeaters if the difference between i) the strength of the SRS received by the base station when the repeaters are in the ON state and ii) the strength of the SRS received by the base station when the repeaters are in the OFF state exceeds a predetermined threshold. In other words, all repeaters may first be operated in the ON state during the UE's SRS transmission. The SRS transmitted by the UE is received by the base station, and the controller 1510 may measure an uplink channel state, such as received power intensity or an RSRP value, for the SRS transmission. Subsequently, all repeaters may be operated in the OFF state for the UE's SRS transmission. Similarly, the base station may measure an uplink channel state, such as a received power intensity, an RSRP value, or the like, for comparison.

When the OFF state measurement value for the SRS decreases by more than a predetermined threshold compared to the ON state measurement value, the corresponding UE may be determined to be located within the coverage of the repeaters.

As such, once it is determined that the UE is within the repeater coverage, the base station may control each of the repeaters to be sequentially turned ON and OFF in order to identify the repeater transferring the SRS of the UE. In other words, the repeater covering the UE may be determined based on the strength of the SRS received by the base station in a state while each repeater is sequentially turned on/off.

According to an example, when it is determined that the UE is within the coverage of the repeaters, the repeater group including the repeater covering the UE may be identified based on the strength of the SRS received by the base station while each of a plurality of repeater groups is sequentially turned ON and OFF. Once the group is identified, the specific repeater covering the UE may be determined based on the strength of the SRS received by the base station while each repeater within the determined repeater group is sequentially turned on/off.

According to another example, the repeater covering the UE may be identified based on the sequence applied to the SRS received by the base station, where different sequences are configured for each repeater.

To that end, the base station may allocate sequence values, such as cyclic shift values or phase rotation/shift values, to be masked when delivering the corresponding the SRS for each repeater. In this case, the time domain and frequency domain resource information for the UE's SRS transmission, designated for relaying by a specific repeater, may be configured through higher layer signaling by the base station or indicated via side control information (SCI).

The controller 1510 may identify the sequence applied to the received SRS and determine that the UE is located within the coverage of the repeater to which the sequence is allocated. In this case, according to an example, a process of determining that the UE's location based on the ON/OFF control of all repeaters described above, may be omitted.

The controller 1510 may perform wireless communication with the UE through the repeater determined to cover the UE. As described above, it is assumed that the UE has been identified as being within the coverage of the repeater. In this case, during the subsequent signal transmission/reception with the UE, the base station may control only the repeater to remain in the ON state, while keeping the other repeaters in the OFF state.

According to the embodiments described above, wireless communication may be performed using a repeater in a wireless network. Further, by controlling only the necessary repeater to operate and removing the unnecessary repeater's relaying operation, it is possible to reduce interference of radio signals and power consumption of the repeater.

The embodiments described above may be supported by the standard documents disclosed in at least one of the radio access systems such as IEEE 802, 3GPP, and 3GPP2. That is, the steps, configurations, and parts, which have not been described in the present embodiments, may be supported by the above-mentioned standard documents for clarifying the technical concept of the disclosure. In addition, all terms disclosed herein may be described by the standard documents set forth above.

The above-described embodiments may be implemented by any of various means. For example, the present embodiments may be implemented as hardware, firmware, software, or a combination thereof.

In the case of implementation by hardware, the method according to the present embodiments may be implemented as at least one of an application specific integrated circuit (ASIC), a digital signal processor (DSP), a digital signal processing device (DSPD), a programmable logic device (PLD), a field programmable gate array (FPGA), a processor, a controller, a microcontroller, or a microprocessor.

In the case of implementation by firmware or software, the method according to the present embodiments may be implemented in the form of an apparatus, a procedure, or a function for performing the functions or operations described above. Software code may be stored in a memory unit, and may be driven by the processor. The memory unit may be provided inside or outside the processor, and may exchange data with the processor by any of various well-known means.

In addition, the terms “system”, “processor”, “controller”, “component”, “module”, “interface”, “model”, “unit”, and the like may generally mean computer-related entity hardware, a combination of hardware and software, software, or running software. For example, the above-described components may be, but are not limited to, a process driven by a processor, a processor, a controller, a control processor, an entity, an execution thread, a program and/or a computer. For example, both the application that is running in a controller or a processor and the controller or the processor may be components. One or more components may be provided in a process and/or an execution thread, and the components may be provided in a single device (e.g., a system, a computing device, etc.), or may be distributed over two or more devices.

The above embodiments of the present disclosure have been described only for illustrative purposes, and those skilled in the art will appreciate that various modifications and changes may be made thereto without departing from the scope and spirit of the disclosure. Further, the embodiments of the disclosure are not intended to limit, but are intended to illustrate the technical idea of the disclosure, and therefore the scope of the technical idea of the disclosure is not limited by these embodiments. The scope of the present disclosure shall be construed on the basis of the accompanying claims in such a manner that all of the technical ideas included within the scope equivalent to the claims belong to the present disclosure.

### CROSS-REFERENCE TO RELATED APPLICATION(S)

This application claims priority to Korean Patent Application Nos. 10-2022-0123458, filed on Sep. 28, 2022, and 10-2023-0131073, filed on Sep. 27, 2023, in the Korean Intellectual Property Office, the disclosure of which is incorporated by reference herein in its entirety. Priority is claimed in other countries other than the United States for the same reason, the disclosure of which is incorporated by reference herein in its entirety.

1. A method for a user equipment (UE) to perform wireless communication using a repeater, the method comprising:
receiving configuration information for a sounding reference signal (SRS) from a base station:
transmitting the SRS to the base station in each of sequential time durations according to an ON/OFF state of each repeater, based on the configuration information for the SRS; and
performing wireless communication with the base station through a repeater which is determined to have (e.g., cover) the UE within its coverage based on the transmitted SRS.

2. The method of claim 1, wherein the UE is determined to be located within its coverage when a difference value between a strength of the SRS received by the base station in the ON state of the repeater and a strength of the SRS received by the base station in the OFF state of the repeater is greater than a predetermined threshold.

3. The method of claim 2, wherein when the UE is determined to be located within coverage of multiple repeaters, one repeater is identified as having the UE within its coverage based on strength of SRS received by the base station while each of the multiple repeaters is sequentially turned ON and OFF.

4. The method of claim 2, wherein when the UE is determined to be located within coverage of multiple repeaters, a repeater group including one repeater having the UE located within the coverage is first identified from a plurality of repeater groups based on strength of SRS received by the base station while each repeater in the plurality of repeater groups is sequentially turned ON and OFF, and
the one repeater is then identified based on the strength of the SRS received by the base station while each of multiple repeaters in the determined repeater group is sequentially turned ON and OFF.

5. The method of claim 1, wherein the repeater is determined (e.g. identified) to have the UE located within its coverage based on a sequence applied to SRS received by the base station, among sequences each configured differently for each of the multiple repeaters.

6. A method for a base station to perform wireless communication using a repeater, the method comprising:
transmitting configuration information for a sounding reference signal (SRS) to a UE;
receiving the SRS from the UE in each of sequential time durations according to an ON and OFF state of each of multiple repeaters, based on the configuration information for the SRS;
determining a repeater having (e.g., covering) the UE located within its coverage among the multiple repeaters, based on the received SRS; and
performing wireless communication with the UE through the determined repeater.

7. The method of claim 6, wherein the UE is determined to be located within coverage of the determined repeater when a difference value between a strength of the received SRS in the ON state of the repeater and a strength of the received SRS in the OFF state of the repeater is greater than a predetermined threshold.

8. The method of claim 7, wherein when the UE is determined to be located with coverage of multiple repeaters, the determined repeater is identified based on the strength of the received SRS while each of the multiple repeaters is sequentially turned ON and OFF.

9. The method of claim 7, wherein, when the UE is determined to be located within coverage of the multiple repeaters,
a repeater group that includes the determined repeater is identified based on the strength of the received SRS while each of a plurality of repeater groups is sequentially turned ON and OFF, and
the determined repeater is identified in the identified repeater group based on the strength of the received SRS while each repeater in the identified repeater group is sequentially turned ON and OFF.

10. The method of claim 6, wherein the determined repeater is identified based on a sequence applied to the received SRS among sequences each configured differently for each of the multiple repeaters.

11. A user equipment (UE) performing wireless communication using a repeater, comprising:
a transmitter;
a receiver; and
a controller configured to control an operation of the transmitter and the receiver, wherein the controller receives configuration information for a sounding reference signal (SRS) from a base station, transmits the SRS to the base station in each of sequential time durations according to an ON and OFF state of each of multiple repeaters based on the configuration information for the SRS, and performs wireless communication with the base station through a repeater determined to have the UE located within its coverage based on the transmitted SRS.

12. The UE of claim 11, wherein the UE is determined to be located within its coverage of the determined repeater when a difference value between a strength of the SRS received by the base station in the ON state of the repeater and a strength of the SRS received by the base station in the OFF state of the repeater is greater than a predetermined threshold.

13. The UE of claim 12, wherein when the UE is determined to be located within coverage of multiple repeaters, one repeater is identified as having the UE within its coverage based on the strength of the SRS received by the base station while each of the multiple repeaters is sequentially turned ON and OFF.

14. The UE of claim 12, wherein when the UE is determined to be located within coverage of multiple repeaters, a repeater group including one repeater having the UE located within the coverage is first identified from a plurality of repeater groups based on strength of SRS received by the base station while each repeater in the plurality of repeater groups is sequentially turned ON and OFF, and
the one repeater is then identified from the identified repeater group based on the strength of the SRS received by the base station while each of multiple repeaters in the determined repeater group is sequentially turned ON and OFF.

15. The UE of claim 11, wherein the repeater is determined to have the UE located within the coverage based on a sequence applied to the SRS received by the base station among sequences each configured differently for the repeaters, respectively.
